(19) United States
(12) Patent Application Publication
(10) Pub. No.: US 2018/0366096 A1
(43) Pub. Date: Dec. 20, 2018

(54) SYSTEM FOR MUSIC TRANSCRIPTION

(71) Applicant: Mark Glembin, Henderson, NV (US)

(72) Inventor: Mark Glembin, Henderson, NV (US)

(21) Appl. No.: 15/623,607

(22) Filed: Jun. 15, 2017

(51) Int. Cl. G10G 3/04; G10G 1/04

(52) U.S. Cl. CPC G10G 3/04; G10H 2210/086; G10G 1/04

(57) ABSTRACT

A system for music transcription that includes: a musical instrument; a computer; a communication link between the musical instrument and the computer; and software residing on memory within the computer adapted to interpret audio sound from the musical instrument and transcript musical notes onto a visible music scale. The musical notes are transcribed onto a treble clef and a bass clef, where the musical instrument includes at least one of a guitar, keyboard, horn, woodwind or other musical instrument. A tablature may also be provided for a stringed instrument. The communication link includes a microphone on the computer, where the microphone transmits music to a processor for interpretation.

### BACKGROUND OF THE INVENTION

### Field of Invention

The present invention relates to a system that transcribes music as it played onto a computer generated musical scale.

### Description of Related Art

Several systems have been developed to implement computer assistance in the teaching and critiquing of music in various aspects. One common system that utilizes a computer is disclosed in U.S. Pat. No. 8,878,043 to Cheever. Cheever discloses a system that determines music keys, music chords or music notes based upon information of movement of a user or user device. The system determines a sequence of musical notes based upon the movement information. The movement is primarily related to the movement of a mobile device and the chords are based upon the direction of travel and so forth. Another example of use of a computer in conjunction with music is disclosed in US Patent Application Publication No. 2014/0305284 to Cosgrove. Cosgrove discloses an apparatus that employs a system of musical notation that represents musical notes in the form of numbers. This numbering system is used in a method to assist students in learning how to play an instrument controlled by a keyboard.

These provide two examples of computer assistance as associated with music creation and/or learning. Most of the systems disclosed in the prior art relate to the computer generation of music or the computer interpretation of music supplied from the instrument to the computer. The systems of the prior art fail to disclose a computer software program implemented to receive audio from a musical instrument to transcribe thereupon onto a visible musical scale.

### SUMMARY OF THE INVENTION

The present invention relates to a system for music transcription that includes: a musical instrument; a computer; a communication link between the musical instrument and the computer; and software residing on memory within the computer adapted to interpret audio sound from the musical instrument and transcript musical notes onto a visible music scale. The musical notes are transcribed onto a treble clef, a bass clef and tablature, where the musical instrument includes at least one of a guitar, keyboard, horn, woodwind or other musical instrument. A tablature must also be provided for a stringed instrument. The communication link includes a microphone or a USB cable connected to the same port used to connect the amplifier on the computer, where the microphone transmits music to a processor for interpretation.

### BRIEF DESCRIPTION OF DRAWINGS

FIG. 1 depicts a system for music transcription in accordance with the present invention.

### DETAILED DESCRIPTION

The present invention relates to a system for musical transcription that includes a computer with a communication link between a computer and a musical instrument. The communication link is in the form of a microphone installed on the computer that receives audio from the musical instrument as it is played. As the audio is reviewed through a processor within the computer a musical scale is transcribed based upon the audio play provided by the musical instrument. This musical scale is shown upon the computer and therefore maps out the notes played by the musical instrument.

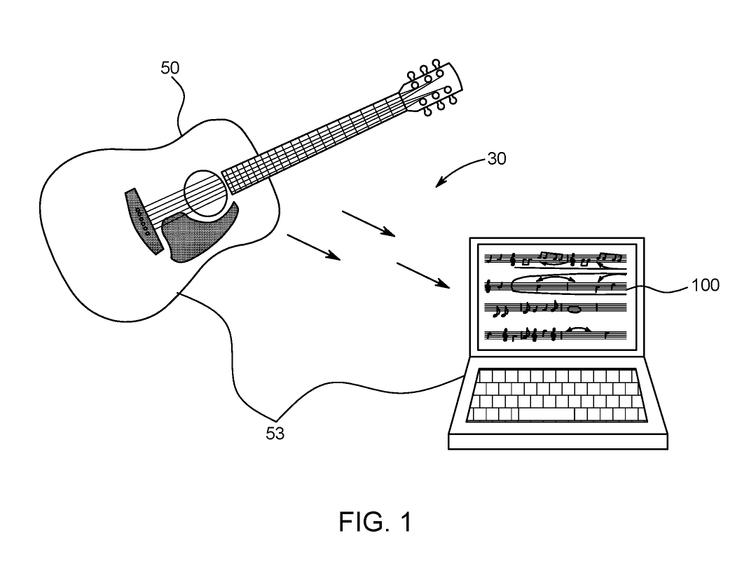

The system according to the present invention is depicted in FIG. 1, wherein in FIG. 1, a guitar 50 is shown transmitting audio 30 to a computer 100. Although a guitar is shown any musical instrument such as a keyboard, horn, woodwind, string instrument, or other musical instrument may be implemented within the system. All musical instruments emit an audio sound that is received by the computer through a microphone or USB cable installed on the computer. This microphone processes the audio sound through the processor controlled by software instructions residing on the memory within the computer. Instructions interpret the audio sound to create a musical scale including notes produced in the audio feed. This visible musical scale is then displayed on the graphical display provided on the computer 100. The visible musical scale also provides chords associated with the string instruments transcribed. In an alternative embodiment, the present invention may be implemented through the use of a USB cable 53. The USB cable 53 in may be plugged into the instrument, such as an electric guitar or other electronic instrument. Audio is received by the computer the USB cable 53. Further, multiple instruments may be connected to the computer so multiple notes and chords may be transcribe during a particular song.

A user may then replay the audio based upon the transcribed music. During replay the user may change a note or chord in order to adjust sound and pitch as needed. Such a feature is effective with in adjusting scales and/or chord progressions, further the software associated with the present invention may include suggestion adjustments to add in the writing process. The present invention may also be used by a vocalist to transcribe notes associated with the song. So, vocal notes and lyrics may be transcribed with the instruments. Other features of the present invention include tablature notation for instrument fingering for fretted stringed instruments such as a guitar.

A user therefore may be able to have a complete display of musical notes on a musical scale during while playing the instrument. The notes are transcribed both upon the treble and bass clefs for the user. In particular with stringed instruments, such as a guitar, a tablature is provided so the user may have a clear notation of fingering associated with the music. This display of music transcribed by the computer provides the user with the ability to detect scales used on the instrument and any dissident notes associated with the audio. Both major and minor scales and modes are also shown along with chords patterns. The instant invention has been shown and described in what it considers to be the most practical and preferred embodiments. It is recognized, however, that departures may be made there from within the scope of the invention and that obvious modifications will occur to a person skilled in the art.

1. (canceled)

2. (canceled)

3. (canceled)

4. (canceled)

5. (canceled)

6. (canceled)

7. (canceled)

8. A method of music transcription comprising the steps of:
establishing a communication link between a musical instrument and a computer;
interpreting audio sound from the musical instrument; and
transcribing musical notes onto a visible music scale.

9. The method according to claim 8, where the music transcription includes a tablature for stringed instruments.

10. The method according to claim 7, where the step of transcribing includes transcribing musical notes on a treble clef.

11. The method according to claim 7, where the step of transcribing includes transcribing musical notes on a bass clef.

12. The method according to claim 7, where the step of transcribing includes transcribing musical notes on a treble clef and a bass clef.

13. The method according to claim 7, where the musical instrument includes at least one of a guitar, keyboard, horn or woodwind.
